(19) United States
(12) Patent Application Publication
(10) Pub. No.: US 2013/0278539 A1
(43) Pub. Date: Oct. 24, 2013

(54) Method and System for Performance Testing Touch-Sensitive Devices

(71) Applicants: Mark F. Valentine, Kenosha, WI (US); John W. Kaehler, Mundelein, IL (US); Alexander Klement, Wheeling, IL (US); Sandeep Vuppu, Sunnyvale, CA (US)

(72) Inventors: Mark F. Valentine, Kenosha, WI (US); John W. Kaehler, Mundelein, IL (US); Alexander Klement, Wheeling, IL (US); Sandeep Vuppu, Sunnyvale, CA (US)

(73) Assignee: Motorola Mobility, Inc., Libertyville, IL (US)

(21) Appl. No.: 13/451,945

(22) Filed: Apr. 20, 2012

(51) Int. Cl. G06F 3/044

(52) U.S. Cl. 345/174

(57) ABSTRACT

A method and apparatus for testing a capacitive touch screen of a touch panel as commonly implemented on mobile and other electronic devices (or another touch-sensing device) are disclosed herein. In at least some embodiments, the method involves placing the touch screen in relation to a photoconductive panel (for example, a panel made from Cadmium Sulfide) so that the device and panel are adjacent to one another. Then, the panel is illuminated in a known manner, for example, by way of an image displayed on a display of the touch panel. Further, upon illumination of the panel, the panel conducts in a manner correlated to the illumination. Due to this conducting, capacitance change(s) occur that should actuate the touch screen in a corresponding manner. The capacitance change(s) detected at the touch screen can be compared with the known illumination pattern to determine whether the touch screen is operating properly.

### FIELD

The present disclosure relates to touch sensing technologies and, more particularly, to methods and systems for performance testing on touch screens, touch panels, and/or other touch-sensitive devices.

### BACKGROUND

Capacitive sensing technology has become a preferred technology for smart phone touch screens or touch panels. Such technology can include, for example, Indium Tin Oxide (ITO) touch screens. Notwithstanding the increasing prevalence of such capacitive touch screens, considerable complicated and expensive instrumentation is typically required to test the operation of these capacitive touch screens, both before and after the touch screens are integrated into touch subsystems and/or overall devices such as electronic devices into which the touch screens and touch subsystems are incorporated.

More particularly, although electrical measurements can be made on the touch screens themselves, such measurements are not useful in indicating the actual sensitivity of the touch screens to physical touches. Rather than using electrical measurements to test operation of the touch screens, robotic equipment sometimes performs physical touches in relation to the touch screens, thereby simulating actual user touches. Use of such robotic equipment is not only complicated and expensive as mentioned above, but also it is difficult to gauge multi-touch performance using this equipment. In other cases, human operators must test the touch screens by applying real touches to the touch screens, which is a process that introduces additional inaccuracies through human error. Given the advent of display modules having integrated touch capabilities, and the ubiquity of such display modules, comprehensive functional testing of the capacitive touch system not only is costly but also has become mandatory or nearly mandatory in the context of manufacturing and operating a wide variety of systems and products, and in performing a wide variety of applications and processes.

For at least these reasons, as well as possibly others, it would be advantageous if an improved method and/or system for testing touch screens (or other touch sensitive devices) could be developed.

### BRIEF DESCRIPTION OF THE DRAWINGS

FIG. 1 is a schematic diagram of a cross-sectional view of an electronic device having a touch screen including both a touch panel and an optical display, positioned in relation to a photoconductive panel that interacts with the touch panel particularly when one or more portions of the optical display are actuated so as to illuminate corresponding portion(s) of the photoconductive panel, in accordance with a first example embodiment;

FIG. 2 is an additional schematic diagram of a perspective side view of multiple electronic devices (each of which can be of the same type, or different types, as that of FIG. 1) and another embodiment of photoconductive panel, where the photoconductive panel is of sufficient size that several (in this example, four) of the mobile devices all can be positioned along the photoconductive panel at the same time;

FIG. 3 is a further schematic diagram showing example internal components of a mobile device, which could be one of the electronic devices of FIGS. 1 and 2;

FIG. 4 is an additional schematic diagram of a mobile device, which could be any of the electronic devices of FIGS. 1, 2, and 3 showing more particularly the touch panel of the mobile device as well as several other exemplary internal components of the mobile device by which operation of the touch panel is controlled;

FIG. 5 is a flow chart showing steps of an example process by which a touch panel for any of the electronic devices of FIGS. 1-4 is performance tested, through the use of a photoconductive panel such as one of those shown in FIGS. 1 and 2;

FIG. 6 illustrates example images that can be output by an optical display of a touch screen such as that of the electronic devices of FIGS. 1-2 when the touch screen is being performance tested in accordance with the process of FIG. 5;

FIG. 7 is a schematic diagram illustrating an alternate embodiment of a photoconductive panel (or portions thereof) in which the photoconductive panel is segmented; and

FIG. 8 illustrates a series of steps in which the photoconductive panel of FIG. 7 can be operated so as to simulate an occurrence of a complex touch or gesture so as to performance test responsiveness of a touch panel (such as that of the electronic devices of FIGS. 1-2) to such touches/gestures.

### DETAILED DESCRIPTION

The present inventors have recognized that capacitive touch panels or other touch-sensing devices can be tested, without physical touching of the devices, by providing capacitive effects identical or similar to those corresponding to physical touches. The present inventors have additionally recognized that such capacitive effects can be provided, so as to simulate physical touches, through the use of a photoconductive panel or structure (e.g., made of Cadmium Sulfide). The photoconductive panel, in combination with the touch panel or other touch-sensing device being tested, can serve as a variable capacitor, with the effective coupling area determined by the size and shape of a light pattern that strikes the photoconductive panel. When the photoconductive panel is connected to an array of earth-ground contacts on one side, and in contact with a touch panel (such as that of a smart phone or other electronic device) on the other side, it becomes possible to create precise zones of capacitive coupling to earth-ground on the touch panel that simulate touches.

By virtue of this fact, it is particularly possible to employ such a photoconductive panel or structure adjacent to or in relation to the touch panel of an optical-display-equipped touch screen of a smart phone or other electronic device to activate the touch panel of the touch screen simply by virtue of the light of the electronic device's display causing conductivity in the photoconductive material at the locations struck by the light. Illumination of the photoconductive material by the light from the display then creates a capacitive effect on the touch panel of the optical-display-equipped touch screen that simulates a user touch. In at least some circumstances, by using particular solid shapes of light on a dark background, as created by the display of the touch screen on the electronic device, distinct regions corresponding to user touches can be simulated (as if they are occurring on the touch panel due to actual user (e.g., finger) touches), simply by actuating the display of the smart phone or other electronic device.

A variety of advantages and benefits can be achieved through the use of one or more embodiments encompassed by the present disclosure. For example, through the use of a photoconductive panel or structure in relation to the touch screen of an electronic device, the touch screen can be tested for its operational effectiveness and status. Further, multiple touch screens can be tested simultaneously (that is, multiple touch screens of possibly multiple electronic devices), to the extent that the photoconductive panel surface is extended in its area (that is, the testing capability is limited only by the working surface area of the photoconductive surface). Also, multiple touches can be generated (simulated) on a single touch screen without instrumentation, limited only by the ability of the touch screen's optical display to generate and manipulate a shape corresponding to each desired touch. Further, through the use of such a photoconductive panel or structure for testing purposes, no calibration or precisely molded fixture is required in order to test the touch screen of a given electronic device, because the touch can be physically referenced to the origin of the optical display of the touch screen and not to the physical confines of the touch panel itself.

In still further embodiments envisioned herein, it is possible to use existing gesture simulating tools in conjunction with certain embodiments of photoconductive surfaces, additionally in conjunction with an electronic device touch screen, in order to simulate a variety of touches or touch motions such as swipes or pinches in relation to the capacitive touch panel/touch screen. In some such embodiments, the gesture simulator technology can turn on and/or off each of the earth-ground contacts of the photoconductive surface to create simple touch or complex touch/gestures. Given that the gesture simulator utilizes electric signals to simulate touches, the turn on/turn off times for these touches and gestures are effectively zero, irrespective of any persistence in the photoconductive surface material's transitions between conductive and non-conductive states.

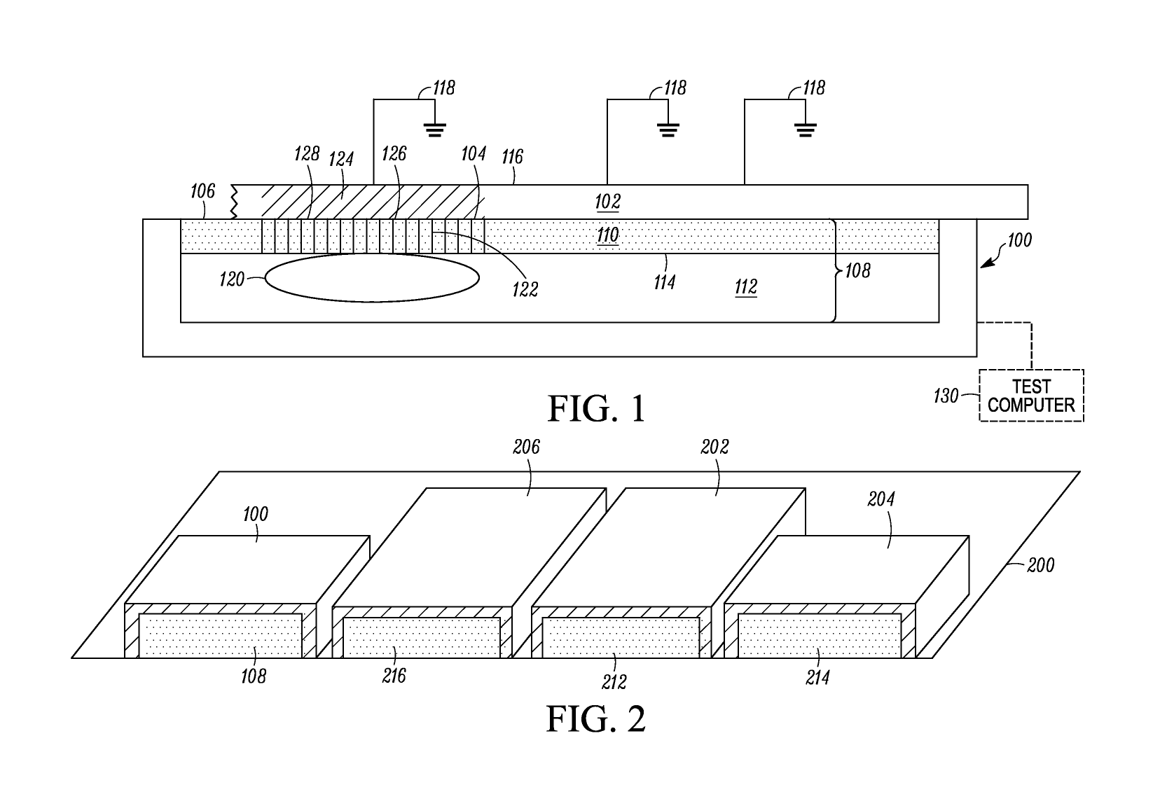

Referring now to FIG. 1, a schematic diagram is provided that shows a cross-sectional view of an example electronic device 100 arranged in relation to a photoconductive panel (which can also be referred to as a “blotter”) 102. The photoconductive panel 102 can be made from various photoconductive materials depending upon the embodiment, and in the present embodiment is made of (or includes) Cadmium Sulfide. As shown, the photoconductive panel 102 in the present embodiment is flat with a contact surface 104 that is configured to be positioned adjacent to and extend across a complementary surface 106 of the electronic device. More particularly as shown, the electronic device 100 includes a touch screen 108 having both a capacitive touch panel 110 and an optical display (e.g., a liquid crystal display, or LCD) 112. The touch panel 110 particularly is arranged along the outer surface of the electronic device 100 and forms the complementary surface 106 along its outer side, and the optical display 112 is arranged within the interior of the electronic device 100 generally extending adjacent to an inner surface 114 of the touch panel 110 that is generally coextensive with the complementary surface 106.

Further as shown, an outer surface 116 of the photoconductive panel 102 that is on the opposite side of the photoconductive panel relative to the contact surface 104 can be coupled to ground via one or more ground connections, which in the present embodiment are shown to include (as an example) three such ground connections 118, albeit the number of ground connections can vary depending upon the embodiment. Although both the touch panel complementary surface 106 and the contact surface 104 are shown to be flat/planar in the present embodiment, in other embodiments it is possible that the two surfaces would have another shape (e.g., convex, concave, or otherwise curved). Regardless of the embodiment, the contact surface of the photoconductive panel and complementary surface of the touch screen will typically need to be adjacent to and in contact with one another (or at least very close to one another) to the extent that it is desired that the conduction operation by the photoconductive panel serves to actuate the touch panel as described in further detail below.

Still referring to FIG. 1, it will be appreciated that typical operation of the touch screen 108 encompasses both actuation of the optical display 112 so as to generate light at one or more portions along the touch panel 110, which are able to pass through the touch panel and be emitted from the electronic device 100, as well as operation of the touch panel 110 to sense user touches or other touch-like contact occurrences along the complementary surface 106. In the present embodiment, the photoconductive panel 102 particularly serves to allow the electronic device 100 to self-actuate its own touch panel 110. This can be achieved by causing optical display 112 to output light at one or more locations or regions such as an example region 120, so that light rays such as light rays 122 are emitted out of the touch screen 108 through the touch panel 110. To the extent that such light rays not only pass out of the touch panel 110 but also encounter the photoconductive panel 102 so as to illuminate portion(s) of that panel, the light rays serve to activate those portion(s) of the photoconductive panel to conduct by virtue of the ground connections 118, which link those portion(s) to ground. (It can be noted that FIG. 1 shows the example region 120 to be an oval, even though FIG. 1 is a cross-sectional diagram, so as to suggest in a figurative manner that the light rays 122 are emanating from a two dimensional region along the inner surface 114.)

Thus, in the present embodiment as illustrated, to the extent that the light rays 122 encounter a portion 124 (shown by cross-hatching) of the photoconductive panel 102 and particularly a section 126 of the contact surface 104 coextensive therewith, conduction occurs between that section 126 and ground by way of the portion 124. Finally, due to the conduction through the portion 124, from the section 126 to ground by way of the ground connections 118, a coextensive section 128 of the complementary surface 106 of the touch screen 108 experiences a capacitance (or related electrical) change in the same or substantially the same manner as would be occurring if a person had touched one of their fingers at that same location along the section 128 of the complementary surface 106. Thus, emission of light in the region 120 causes, by virtue of the presence of the photoconductive panel 102, a corresponding actuation of the touch panel 110 at the exact location of the region 120 as if the touch screen 108 had been touched at that location, provided that the touch screen is in fact operating properly.

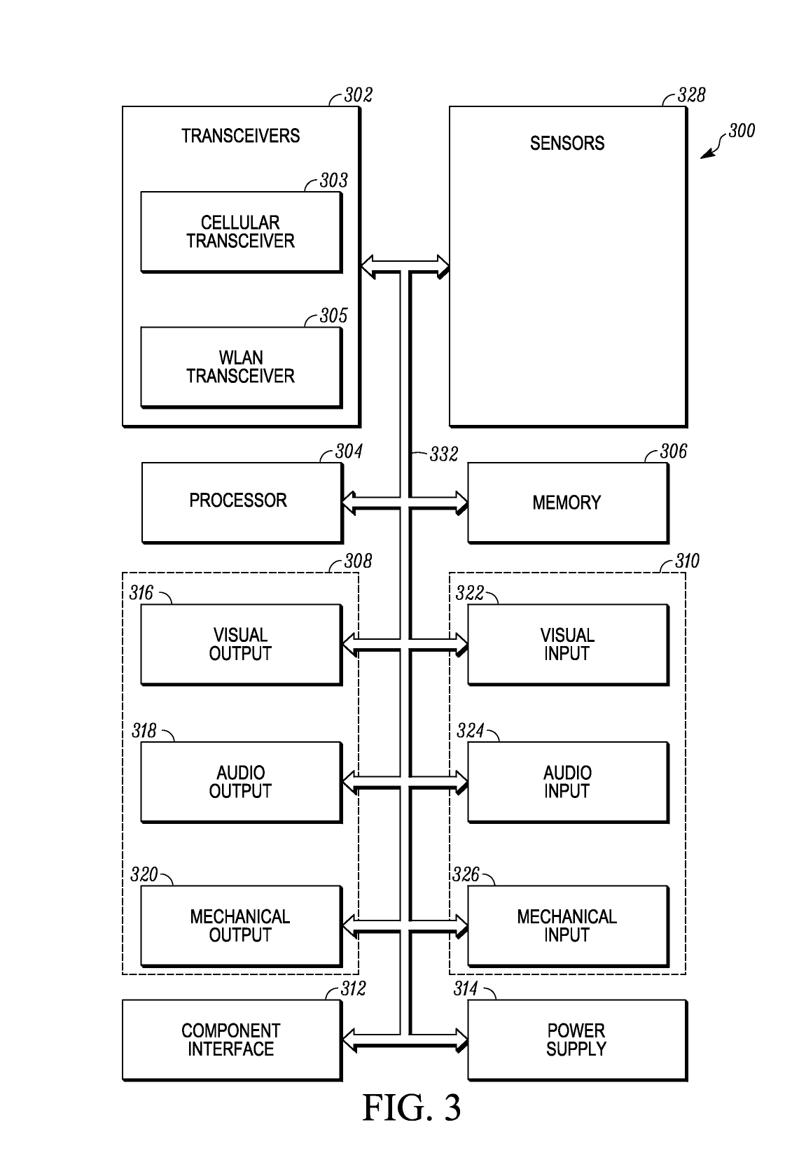

In the embodiment of FIG. 1, the photoconductive panel 102 is shown to be smaller in extent (e.g., less wide or less in its surface area overall) than the touch screen 108 and the electronic device 100. However, this need not be the case in other embodiments. For example, referring to FIG. 2, in an alternative embodiment, the photoconductive panel 200 has an area that is much greater than the surface area of the touch screen 108 of the electronic device 100 and in fact is sufficiently large that multiple electronic devices including not only the first electronic device 100 but also additional electronic devices 202, 204, and 206 all can be positioned adjacent to the photoconductive panel 200, particularly so that respective touch screens 108, 212, 214, 216 thereof are all in physical contact with the photoconductive panel 200 simultaneously. Thus it will be appreciated that embodiments of the present disclosure can be utilized in manufacturing environments in which the touch panels (and touch screens) of many electronic devices are being simultaneously or substantially simultaneously tested. In some such embodiments, the mobile devices are laid physically down on top of/over a photoconductive panel such as the photoconductive panel 200 so as to be supported by the photoconductive panel (as opposed to the arrangement shown in FIG. 1, where the photoconductive panel 102 is positioned vertically atop the electronic device 100). The exact physical arrangement of touch panel/screen relative to the photoconductive panel or structure can vary depending upon the embodiment in additional manners besides those shown in FIGS. 1 and 2.

It should be noted that, although in the present embodiment the electronic device 100 of FIG. 1 and each of the additional electronic devices 202, 204, and 206 of FIG. 2 are smart phones, the present disclosure is intended to encompass and be implemented in relation to any of a variety of electronic devices that can include capacitive touch panels, touch screens, or other touch-sensitive devices including, for example, cellular telephones, personal digital assistants (PDAs), other handheld or portable electronic devices, headsets, desktop monitors, televisions, MP3 players, battery-powered devices, wearable devices (e.g., wristwatches), radios, navigation devices, tablet computers, laptop or notebook computers, pagers, PMPs (personal media players), DVRs (digital video recorders), gaming devices, remote controllers, PC mouse pads, and other electronic devices. Further, even though FIG. 1 and FIG. 2 concern the electronic devices 100, 202, 204, and 206, it should further be understood that the present disclosure is not intended to be limited to similarly-constructed electronic devices. For example, some devices 202, 206 can be tablets while other devices 100, 204 are smart phones.

Although FIG. 1 and FIG. 2 particularly show embodiments in which a fully-assembled touch screen within a complete electronic device (e.g., a smart phone) is being tested, as can be performed at or near the end of the manufacturing process of such an electronic device, the present disclosure is also intended to encompass embodiments and testing procedures that are applicable to other devices being tested and to other testing circumstances as well. For example, in some other circumstances, testing can be performed simply in relation to a touch panel such as the touch panel 110 all by itself. For such testing to be performed, light for illumination of the photoconductive panel 102 (or 200) can be provided from a source other than an optical display associated with the touch panel, for example, from a separate optical display controlled by the test computer 130, which can for example serve as a base upon which the touch panel can be supported, with the photoconductive panel then being placed above the touch panel.

Also for example, in some other circumstances, testing can be performed simply in relation to an assembled touch screen by itself having both a touch panel and an optical display such as the touch screen 108. Further, in addition to performing testing upon a fully-completed electronic device such as the electronic device 100, testing can also be performed upon other sub-assemblies of a completed electronic device (e.g., a subassembly including both the touch system and other components but that does not yet constitute the fully-completed electronic device being manufactured).

From the above, it should be also appreciated that, with respect to testing procedures, testing can be performed at a variety of times and junctures. For example, testing can be performed upon a touch panel or other touch-sensitive element prior to being assembled to an optical display component, or after components are assembled to form a completed touch-screen (e.g., after a lamination process providing a laminated display) or other touch system or other electronic device subcomponent (e.g., a faceplate assembly of a smart phone). Also, testing can be performed after the entire electronic device has been fully manufactured (e.g., upon a fully-completed smart phone), near or at the end of the manufacturing process. Further, testing can be performed upon a fully-completed electronic device at a time after it has been manufactured (e.g., after its sale, for routine maintenance, etc.).

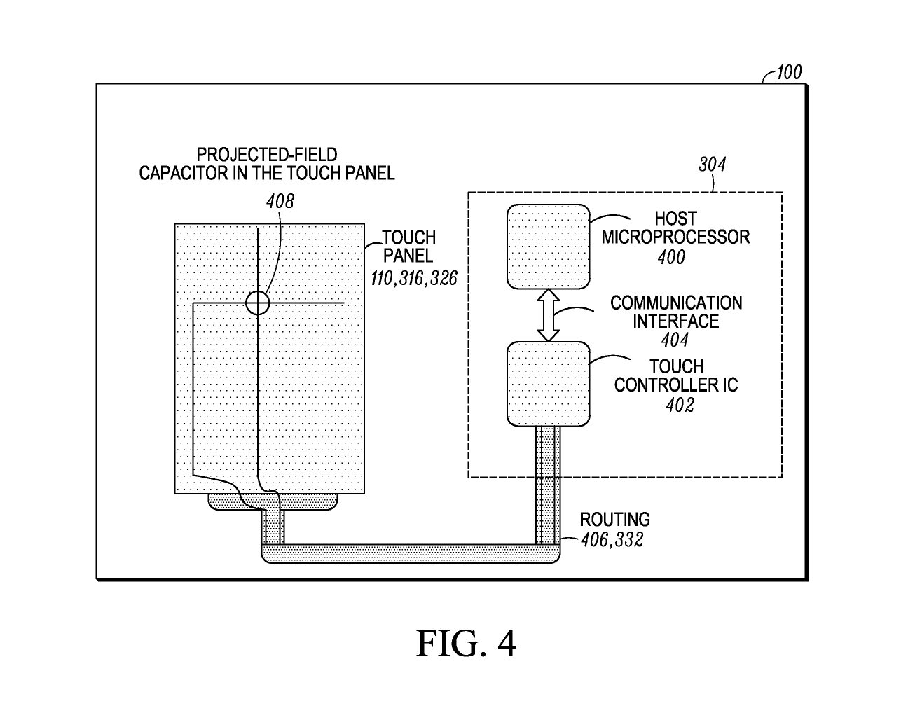

As discussed in further detail herein, in at least some embodiments any one or more of a variety of test procedures can be performed, through the use of one or more photoconductive panel(s) such as the photoconductive panels 102, 200 of FIG. 1 and FIG. 2, by which the operation of touch-sensitive devices such as the touch panels of the touch screens 108, 212, 214, 216 of the electronic devices 100, 202, 204, 206 can be tested. In at least some such embodiments, testing operations can be performed entirely or substantially under the control of the device under test (DUT), for example, by a microprocessor or other processing portion of the electronic device (such as described below in relation to FIG. 3). In at least some other embodiments, testing operations can be performed entirely or substantially under the control of another controller that is distinct from the DUT, for example, a test computer 130 as shown in FIG. 1 (which is shown in phantom to indicate that the presence of such a computer is optional and can vary depending upon the embodiment), or testing operations can be performed in a collaborative manner involving the control or influence of multiple control devices including one or more control devices of the DUTs and one more control devices distinct from the DUTs.

Turning to FIG. 3, a block diagram shows in more detail example internal components 300 of the electronic device 100 of FIG. 1 in accordance with one embodiment. The internal components 300 can be considered equally representative of internal components of each of the additional electronic devices 202, 204, and 206 of FIG. 2. As shown, the components 300 include one or more transceivers 302, a processor portion 304 (which can include, for example, one or more of any of a variety of devices such as a microprocessor, microcomputer, application-specific integrated circuit, etc.), a memory portion 306, one or more output devices 308, and one or more input devices 310. In at least some embodiments, a user interface component is present that includes one or more of the output devices 308, such as a display, and one or more of the input devices 310, such as a keypad or touch sensor. In the present embodiment, the touch screen 108 with the capacitive touch panel 110 and optical display 112 can be considered to constitute one such combination user interface component. The internal components 300 further include a component interface 312 to provide a direct connection to auxiliary components or accessories for additional or enhanced functionality. The internal components 300 preferably further include a power supply 314, such as a battery, for providing power to the other internal components and enabling the electronic device 100 to be portable. All of the internal components 300 can be coupled to one another, and in communication with one another, by way of one or more internal communication links 332 (e.g., an internal bus).

Each of the transceivers 302 in this example utilizes a wireless technology for communication, which can include for example (but is not limited to) cellular-based communication technologies such as analog communications (using AMPS), digital communications (using CDMA, TDMA, GSM, iDEN, GPRS, EDGE, etc.), and next generation communications (using UMTS, WCDMA, LTE, IEEE 802.16, etc.) or variants thereof, or peer-to-peer or ad hoc communication technologies such as HomeRF (radio frequency), radio frequency identification (RFID), or near field communication (NFC), Bluetooth and IEEE 802.11(a, b, g or n), or other wireless communication technologies such as infrared or ultrasonic technology. In the present embodiment, the transceivers 302 include a cellular transceiver 303 and a wireless local area network (WLAN) transceiver 305, although in other embodiments only one of these types of wireless transceivers is present (or alternatively possibly neither of these types of wireless transceivers, and/or possibly other types of wireless or wired transceivers is/are present).

Operation of the transceivers 302 in conjunction with others of the internal components 300 of the electronic device 100 can take a variety of forms. Among other things, the operation of the transceivers 302 can include, for example, operation in which, upon reception of wireless or wired signals, the internal components detect communication signals and one of the transceivers 302 demodulates the communication signals to recover incoming information, such as voice and/or data, transmitted by the wireless or wired signals. After receiving the incoming information from one of the transceivers 302, the processor portion 304 formats the incoming information for the one or more output devices 308. Likewise, for transmission of wireless or wired signals, the processor portion 304 formats outgoing information, which may or may not be activated by the input devices 310, and conveys the outgoing information to one or more of the transceivers 302 for modulation to communication signals. The transceivers 302 convey the modulated signals by way of wireless and (possibly wired as well) communication links to other (e.g., external) devices.

Depending upon the embodiment, the input and output devices 308, 310 of the internal components 300 can include a variety of visual, audio, and/or mechanical input and output devices. In the electronic device 100 of FIG. 1, the visual output components 316 particularly include the optical display (or video screen) 112 provided by the touch screen 108, which can be a LCD display, as well as other devices such as a light emitting diode indicator. The audio output components 318 can for example include parts such as a loudspeaker, an alarm, and/or a buzzer, and the mechanical output components 320 can include other elements such as other types of vibrating mechanisms (e.g., rotary vibrators, linear vibrators, variable speed vibrators, and piezoelectric vibrators).

Likewise, by example, the input components(s) 310 can include one or more visual input components 322, one or more audio input components 324, and one or more mechanical input components 326. In the electronic device 100 of FIG. 1, for example, the mechanical input components 326 not only include the capacitive touch panel 110 of the touch screen 108, but also can include other parts such as alpha-numeric keys and/or a navigation element (or navigation cluster), as well as various selection buttons (e.g., a “back” button), a touch pad, another capacitive sensor, a flip sensor, a motion sensor, and a switch. The visual input components 322 can include, for example, infrared sensors or transceivers and/or other optical or electromagnetic sensors (for example, a camera), and the audio input components 324 can include parts such as a microphone. Generally speaking, actions that can actuate one or more of the input components 310 can include not only the physical pressing/actuation of the touch panel 110 or other buttons or other actuators, but can also include, for example, opening the electronic device 100, unlocking the device, moving the device to actuate a motion, moving the device to actuate a location positioning system, and operating the device.

As shown in FIG. 3, the internal components 300 of the electronic device 100 also can include one or more of various types of sensors 328 that are coupled to other components by the internal communication links 332. Depending upon the embodiment, the sensors 328 can include any one or more of, for example, accelerometers, proximity sensors (e.g., a light detecting sensor or an ultrasound transceiver), capacitive sensors, temperature sensors, altitude sensors, or location circuits that can include, further for example, a Global Positioning System (GPS) receiver, a triangulation receiver, a tilt sensor, a gyro or gyroscope, an electronic compass, a velocity sensor, or any other information collecting element that can identify a current location or user-device interface (carry mode) of the electronic device 100. For purposes of the present discussion, the sensors 328 will be considered to not include elements that can be considered among the input components 310, such as the touch panel 110, although it should be appreciated that the terms sensor and input component can also easily be defined in a different manner such that some sensors are input components and/or vice-versa.

The memory portion 306 of the internal components 300 can encompass one or more memory components or databases of any of a variety of forms (e.g., read-only memory, random access memory, static random access memory, dynamic random access memory, etc.), and can be used by the processor portion 304 to store and retrieve data. Also, in some embodiments, the memory portion 306 can be integrated with the processor portion 304 in a single component (e.g., a processing element including memory or processor-in-memory (PIM)), albeit such a single part will still typically have distinct portions/sections that perform the different processing and memory functions and that can be considered separate elements. The data that is stored by the memory portion 306 can include, but need not be limited to, operating systems, software applications, and informational data.

More particularly, each operating system includes executable code that controls basic functions of the electronic device 100, such as interaction among the various components included among the internal components 300, communication with external devices via the transceivers 302 and/or the component interface 312, and storage and retrieval of applications and data, to and from the memory portion 306. Each application includes executable code that utilizes an operating system to provide more specific functionality for the electronic device 100, such as file system service and handling of protected and unprotected data stored in the memory portion 306. Informational data is non-executable code or information that can be referenced and/or manipulated by an operating system or application for performing functions of the electronic device 100.

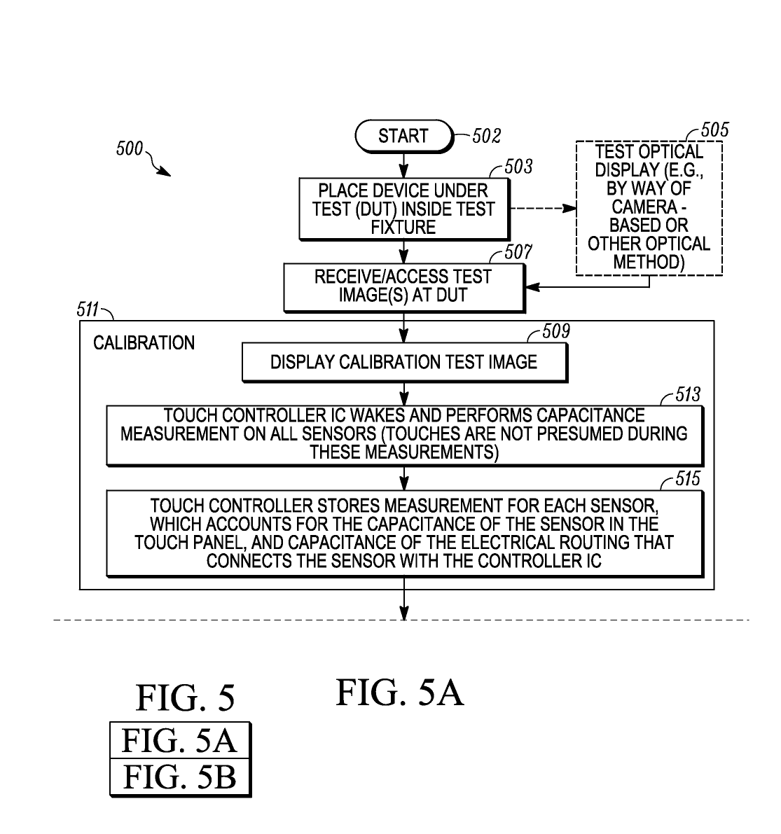

Turning to FIG. 4, certain of the internal components 300 of the electronic device 100 (which again in the present embodiment is a smart phone) are shown in more detail. FIG. 4 can again be considered equally representative of features of the additional electronic devices 202, 204, and 206 of FIG. 2. FIG. 4 particularly shows the touch panel 110 of the touch screen 108, which as discussed above includes both the touch panel and the optical display 112, and which can be considered both one of the mechanical input components 326 and one of the visual output components 316 of the electronic device 100. In addition to the touch panel 110, the electronic device 100 particularly includes both a host microprocessor 400 and a touch controller integrated circuit 402 that is in communication with the host microprocessor 400 via a communication interface 404, and one or more routing connections 406 connecting the touch controller integrated circuit 402 with the touch panel 110 (or electrodes of the touch panel).

The host microprocessor, touch controller integrated circuit 402, and communication interface 404 can all be considered part of the processor portion 304 of FIG. 3, and the one or more routing connections 406 can be considered as constituting part of the internal communication links 332 of FIG. 3 (alternatively, the communication interface 404 can also be considered part of the internal communication links 332). Further, it will be understood that the touch panel 110 includes multiple capacitance-sensing components or elements therewithin, which in the present embodiment are projected-field capacitors embedded in the touch panel, as represented by a single one of the projected-field capacitors 408 shown in FIG. 4. Different one(s) of the projected-field capacitors 408 at different locations within the touch panel 110 are actuated depending upon where the touch panel 110 is touched by a user (or other entity touching the touch panel, such as a robot), or where along a contact surface of a photoconductive panel adjacent to the touch panel (such as the contact surface 104 of the photoconductive panels 102) the photoconductive panel is illuminated as discussed herein.

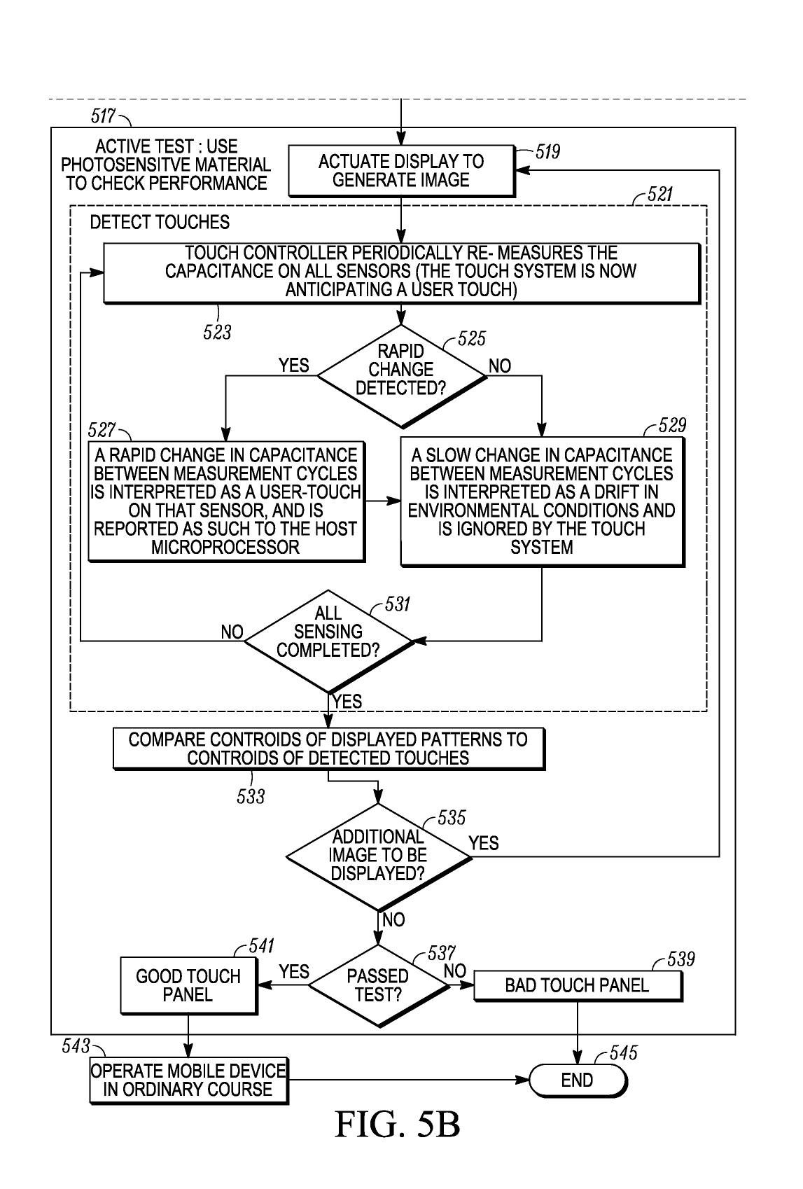

Turning to FIG. 5, the internal components 300 of the electronic device 100 shown in FIGS. 3 and 4 (and particularly FIG. 4) providing touch panel control can operate as shown in FIG. 5 to calibrate, test, and operate the touch panel 110. As noted earlier, the testing process can be controlled in a variety of manners, under the influence of one or more of a variety of different control devices, depending upon the embodiment. In at least some embodiments, control of the testing process is autonomous, that is, the testing process is controlled by the mobile device, electronic device, or other device under test (DUT) having the touch panel or other touch-sensing device being tested.

For example, supposing the DUT is the electronic device 100 of FIG. 1, control of the testing process can be exercised by the processor portion 304 (shown in FIG. 3) of the electronic device 100. Such autonomous testing can include not only testing of the touch system, but also calibration of the touch system. Log files of how long and how strongly the corrective measures were needed to converge on desired performance can be used for manufacturing processes to improve yield of touch system components, possibly including not only the touch panel but also the optical display. In other cases, the testing process can instead be controlled by, or additionally be controlled under the influence of, one or more control devices that are distinct from the DUT, such as the test computer 130 shown in FIG. 1. Control of testing by way of one or more control devices external to the DUT can particularly offer an opportunity to monitor calibration procedures and related data of interest during testing on a real-time basis as testing is occurring, rather than merely reviewing results of tests after the testing is complete.

As shown in FIG. 5, the flowchart 500 upon commencing operation at a start step 502 then proceeds to a step 503, at which the electronic device 100 or other device under test (DUT) having a touch panel (or other touch-sensing device) is placed inside a test fixture so that the touch panel (or other touch-sensing device of the DUT) is positioned adjacent to a photoconductive panel such as the photoconductive panel 102 of FIG. 1 or the photoconductive panel 200 of FIG. 2. The test fixture can be, for example, a compartment having the photoconductive panel positioned along a floor of the compartment, where the compartment can be closed off or sealed from the outside environment so as to prevent light from extraneous light sources from reaching the photoconductive panel.

Following the step 503, the process then advances either directly to a step 507 or indirectly to the step 507 via an optional step 505 (shown in phantom to indicate it being an optional step). As shown, the optional step 505 involves testing of the optical display of the touch screen 108 (e.g., by way of optical testing methods involving a camera or other suitable methods). Upon completion of the step 505 (if performed) or otherwise upon completion of the step 503, the process next advances to step 507, at which test image information regarding one or more test images is received by and/or accessed by the DUT. The step 507 is intended to encompass several possible implementations. That is, in at least some embodiments, the DUT needs to receive one or more test image(s) from a separate source such as the test computer 130 of FIG. 1. In other embodiments, test images are already present at the DUT (e.g., such test images are stored on the memory portion 306 at the time the DUT is originally manufactured), and thus the test images need not be received at the step 507 but rather only are triggered or accessed (e.g., from the memory portion 306 by the processor portion 304 of the electronic device 100) at the step 507.

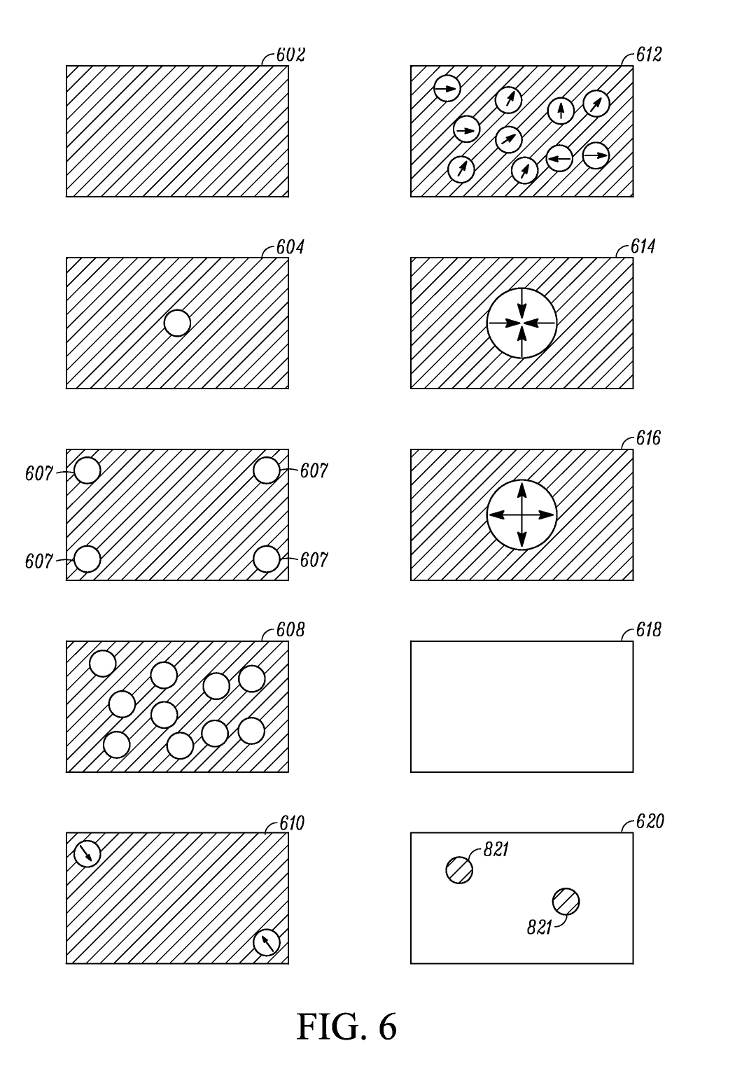

The test images can take any variety of different types or forms depending upon the embodiment or circumstance, and several example test images are discussed below with reference to FIG. 6. Although not shown in FIG. 6, it should be appreciated that the concept of test images employed herein should be broadly understood as encompassing a variety of types of images and image-like items including, among other things, video files. In particular with respect to such video files, these can in some embodiments be played back by the electronic device being tested, or wirelessly streamed to that electronic device. Also, in some such embodiments, a single time-stamped log file generated by the touch system of the DUT in response to such video files can then be processed by a software application (internally or externally with respect to the electronic device) to generate test results.

Following the step 507, the process then involves performance of a calibration operation 511 that particularly includes, as shown, steps 509, 513, and 515. At the step 509, a test image suitable for performing the calibration process is displayed. As discussed further below, such a test image can be, for example, a blank screen of a particular uniform color (e.g., entirely black or entirely white). Next, at the step 513, the touch controller integrated circuit 402 (which can again be considered part of the processor portion 304) awakens and performs a capacitance measurement on all capacitance sensors. That is, in the present embodiment, all of the projected-field capacitors 408 of the touch panel 110 are measured. It is presumed during this operation that the touch panel 110 is not experiencing touches during these measurements. Next, at the step 515, the touch controller integrated circuit 402 stores the measurements received from each of the capacitance sensors (that is, each of the projected-field capacitors 408). Each of these measurements accounts for the capacitance of the sensor in the touch panel 110 and also the capacitance of the electrical routing 406 that connects the sensor with the touch controller integrated circuit 402.

As mentioned, the aforementioned steps 509, 513, and 515 can be considered a calibration process (shown as the calibration operation 511) and, after these steps are performed, normal touch panel operation for sensing of touches can be performed. At this point, an active test operation 517 of the touch panel involving the use of the photoconductive panel with the photosensitive material (again for example the photoconductive panel 102 or 200) to check performance can begin. In the present embodiment, the active test operation 517 can be viewed as including first, second, third, fourth, fifth, sixth, and seventh steps 519, 521, 533, 535, 537, 539, and 541, respectively, with the second step 521 additionally including several substeps as discussed in further detail below. More particularly, at the first step 519, an optical display associated with the touch panel (e.g., the optical display 112 of the touch screen 108 having the touch panel 110) is actuated to generate an image based upon the test image information received at the step 507.

Next, at the second step 521, the touch panel 110 and related touch system components (e.g., the components of the electronic device 100 shown in FIG. 4) are operated to detect touches at the touch panel in response to the image being displayed at the substep 519. The second step 521 particularly includes first, second, third, fourth, and fifth substeps 523, 525, 527, 529, and 531, respectively (from the perspective of the DUT), in which a touch or touches are detected particularly because light from the optical display actuated at the substep 519 passes through the touch panel 110 and reaches the photoconductive panel so as to illuminate portion(s) of that photoconductive panel and, as a result of the operation of the photoconductive panel in response to being illuminated, capacitance change(s) occur(s) at the surface of the touch panel that is/are then detected as one or more touches.

Thus, at the first substep 523, the touch controller integrated circuit 402 measures and periodically re-measures the capacitance on all of the capacitance sensors of the touch panel 110 (that is, all of projected-field capacitors 408), with the touch system now anticipating that touches (in this case, simulated or test touch events) are occurring. Next, at the second substep 525, the touch controller integrated circuit 402 particularly attempts to determine whether a rapid change has occurred between measurement cycles. If a rapid change is detected, then the process advances to the third substep 527. At the third substep 527, a rapid change in capacitance detected at given capacitance sensor(s) (that is, at one or more of the projected-field capacitors 408) between measurement cycles is interpreted as the occurrence of a touch (in this case, a simulated or test touch event) and is reported as such by the touch controller integrated circuit 402 to the host microprocessor 400.

Alternatively, if no rapid change is detected at the substep 525, or subsequent to the substep 527 if the substep 527 is performed, at the fourth step 529 the touch controller integrated circuit 402 further determines whether a slow change in capacitance between measurement cycles has occurred. If so, the slow change is interpreted as a drift in environmental conditions and is ignored by the touch controller integrated circuit 402 (or by the touch sensing system generally). In at least some embodiments, the step 529 can further include eliminating or readjusting tolerances of the capacitance sensors (again, in this embodiment, the projected-field capacitors 408) in view of the slow change. Upon completion of the substep 529, at the fifth substep 531, the touch controller integrated circuit 402 determines whether all sensing has been completed—that is, whether further sensing is anticipated or desired to be performed. If all sensing has not yet been completed, then the process is returned to the first substep 523 at which the capacitance at the various capacitance sensors is re-measured. Alternatively, if all sensing has been completed at the fifth substep 531, then the touch detection associated with the second step 521 is completed.

Following the step 521, the DUT—or more particularly one or more of the processor portions thereof, such as the touch controller integrated circuit 402 or host microprocessor 400 of FIG. 4—performs one or more operations to determine whether the detected touch information obtained at the substep 521 properly corresponds to the test image that was displayed at the step 519. In the present embodiment, as noted in the third step 533, these operation(s) particularly include processing to compare centroids of display patterns (characteristics of the test image) to centroids of detected touches. Comparisons of centroids is a useful technique because, typically, both real touches (e.g., from user fingers) as well as simulated touches resulting from typical test images (including for example some of those shown in FIG. 6) are circular, generally circular, or at least rounded in shape. Nonetheless, in other embodiments or circumstances, it is also possible for other types of comparisons or processing operations to be performed at the step 533, for example, comparisons with respect to other characteristics of portions of the test image and detected touch patterns.

Upon completion of the third step 533, a given active test associated with the particular test image displayed in accordance with the first step 519 has been completed. However, in some embodiments or circumstances, it can be desirable for more than one test to be performed. As will be discussed further below, for example, different test images can be particularly suited for allowing testing of particular respective types of operation of the touch panel, and thus it can be desirable to test multiple different types of operation of the touch panel by performing multiple successive active tests using multiple different test images. Thus, as shown in FIG. 5, upon completion of the third step 533 it is determined (e.g., by the processor portion 304 if the processor portion is controlling the overall testing procedure, or some other control component as appropriate) at the fourth step 535 whether there is yet another test image or test images to be displayed and correspondent active test(s) to be run. If the answer is yes, the process returns to the first step 519 at which a different test image is displayed, and then touch detection and comparison of the steps 521 and 533 again ensue.

Alternatively if at the fourth step 535 it is determined that all test image(s) of interest have been displayed (and correspondingly that all test(s) of interest have been run), then the process instead advances to the fifth step 537, at which the processor portion 304 determines whether the touch panel 110 of the DUT has passed the performance test. If the performance test has not been passed, the process advances to the sixth step 539 at which it is determined that the touch panel is “bad”. Alternatively, if the test has been passed as determined at the fifth step 537, then the touch panel is determined to be a “good” touch panel at the seventh step 541. Upon performance of either the sixth step 539 or the seventh step 541, the active test operation 517 is completed.

If the active test operation 517 concluded with a “bad” determination at the step 539, then the process of the flow chart 500 is shown to end immediately at an end step 545. Alternatively, if the active test operation 517 concluded with a “good” determination, then the DUT can be operated in the ordinary course (presumably after being removed from the test fixture) as indicated by a step 543 prior to the process ending at the step 545 (alternatively, the subprocess can simply proceed from the substep 541 directly to the substep 545, it being understood that the DUT has been approved and is ready for other manufacturing operations, tests, sale, and/or use). It should be further appreciated that, during ordinary operation at the step 543, in at least some embodiments the DUT can operate to detect touches in accordance with the same substeps 523, 525, 527, 529, and 531 involving touch detection as are performed during the second (touch detection) step 521 during the testing procedure.

Notwithstanding the particular steps shown in the FIG. 5, it will be understood that portions of the overall process and subprocesses thereof represented by the flow chart 500 can be repeated or modified depending upon the embodiment or circumstance. For example, in some circumstances, additional tests of one or both of the touch panel and/or the optical display can be performed. Also, it is envisioned that in at least some embodiments and circumstances, testing can involve the use of test images that evolve over time, so as to determine whether the touch panel adequately senses temporally-evolving or changing touches such as gestures (or whether the optical display is capable of adequately displaying temporally-evolving or changing imagery). It should also be appreciated that, although calibration procedures can be performed (e.g., in accordance with the calibration operation 511) prior to or as part of the other testing steps discussed herein, the performance testing of a touch panel of a touch screen with an optical display in accordance with the above-discussed techniques need not involve any special consideration of whether the touch panel or optical display are aligned with the chassis or other physical structure of the electronic device or other DUT or even aligned with the text fixture. Typically, a calibration process establishing relative alignment between the touch panel and optical display is sufficient to allow for proper testing and operation.

Referring now to FIG. 6, the test images that are displayed by the optical display (e.g., the optical display 112) at the step 509 during the calibration operation 511 and at the step 519 during the active test operation 517 can vary considerably depending upon the embodiment or circumstance. FIG. 6 is intended to show several example test images that can be used under various circumstances, although numerous other test images are also possible. As shown in FIG. 6, a first test image 602 can simply be a full black screen. As already noted, such a test image can also be used for calibrating the test system. Additionally as shown, second, third, fourth, fifth, sixth, seventh, and eighth test images 604, 606, 608, 610, 612, 614, and 616, respectively, each include one or more white (or bright) circular or otherwise rounded formations surrounded by an otherwise black (or darkened) background, and each of these test images is particularly suited for particular testing goals.

More particularly with respect to the second test image 604, which includes merely a single white circle surrounded by a black background, this test image is particularly suitable for simulating a single user touch during the process of testing the operation of a touch-sensing device such as the touch panel 110. That is, when the second test image 604 is displayed during the testing process, the light from the single white circle causes the photoconductive layer (e.g., a photoconductive panel such as the photoconductive panels 102, 200 of FIG. 1 and FIG. 2) facing the white circle to become conductive and, due to the newly-formed conductance of the photoconductive layer (e.g., to ground), the capacitance sensed by the touch-sensing device of the DUT (e.g., the touch panel 110) layer decreases (hopefully quickly per steps 523, 527) and is interpreted as a touch event.

Additionally for example, both the second test image 604 and also the third test image 606 (which in contrast to the second test image includes four white circles 607 positioned at each of the respective four corners of the image, again surrounded generally by the black background) are particularly suitable for use in checking alignment of a touch panel such as the touch panel 110 with a display panel such as the display 112. That is, the second and third test images 604, 606 are particularly suitable for calibration of the touch-sensing device relative to the display panel that is displaying the second test image (e.g., calibration of the touch panel 110 in relation to the optical display 112).

For example, if a white dot image with a centroid such as the second test image 604 is positioned and displayed/turned on at the exact center of the optical display (for example, at coordinates 0, 0 thereof), but the touch panel records a touch event at a different location not exactly corresponding to the exact center of the optical display (for example, at coordinates 10, 10 of the touch panel), the touchscreen controller can be calibrated to match the test image display coordinates with the test result touch panel coordinates.

Also, if the white dot images of the third test image 606 are displayed at the extreme corners (e.g., at coordinate values (−100, −100), (−100, 100), (100, 100), and (100, −100)) of the optical display panel but the touch panel senses touches at skewed corners (e.g., at coordinates values (−95, −98), (−98, 95), (95, 98), (98, −95)) then the touch controller can be calibrated to properly correlate the touch panel to the optical display panel. Note that the white dots of test image 606 may be displayed one at a time, or several (up to all four) at a time.

The fourth test image 608 includes not merely four but instead ten of the white circles positioned within the interior of the image at various locations and can be used to check a maximum number of touches detectable at a given time. The white dots of the test image 608 can be shown all at once (which can emulate the test case of two fingers landing on the touch screen prior to a “pinch” or “zoom” gesture) or in a cumulative manner (which can emulate the test case of two or more fingers landing on the touch screen at different times as part of a “staggered-two-finger-tap” gesture). For example, a first white dot is shown, then a second white dot is shown in addition to the first white dot. The image can continue to add white dots until all ten white dots are shown.

The fifth test image 610 includes two of the white circles respectively positioned proximate to opposed corners of the rectangular test image. In this example, arrows are demarcated on each of the white circles that point towards one another, as an indication that in this embodiment the test image varies over time and the white circles are modified over time so as to approach one another (to be clear, notwithstanding the presence of the arrows shown in FIG. 6, the actual test image does not include the arrows themselves). The test image 610 thus is an example of an evolving test image that can involve repeated performance of some or all of the steps 519, 521, 533, and 535 (and all of the substeps 523, 525, 527, 529, 531 of the step 521) of FIG. 5. The test image 610 can be particularly used to check tracking and minimum pinch distance (minimum pinch distance being understood to be a minimum distance over which two user fingers such as a thumb and an index finger need to approach one another in order for the touch screen to detect a “pinching” gesture). It should be noted that the speed at which the white circles approach one another can vary to check touch panel “lag” as well.

As for the sixth test image 612, this test image again is shown as including ten of the white circles as were shown in the test image 608 except, in this example, each of the circles again is shown to include a respective arrow demarcated therein. The arrows, although not actually part of the test image that is displayed, are intended to indicate that the test image is being updated over time to show the white circles moving around to different locations in the image, in this case in a random manner. Like the test image 608, the moving white dots can be shown all at once or in a cumulative manner starting with one moving white dot, adding another moving white dot, and continuing until all ten moving white dots are shown. Thus, use of the sixth test image 612 can again involve repeated performance of steps of the process of FIG. 5 over time. Also, use of the sixth test image 612 again can be useful to check tracking and minimum pinch distance.

The seventh test image 614 and eighth test image 616 each show a larger white circle within the black background but, in the case of the seventh test image 614, the white circle is shown with inwardly pointing arrows and, in the case of the eighth test image 616, the white circle is shown with outwardly pointing arrows. As with the arrows shown in regards to the test images 610 and 612, the arrows of the test images 614 and 616 are not actually present in the test image but merely are provided to indicate that, over time, the test image 614 is updated such that the white circle gets progressively smaller and further that, over time, the test image 616 is updated such that the white circle gets progressively larger. Use of the test images 614 and 616 can involve repeated performance of steps of the process of FIG. 5 over time. By displaying the test image 614 in such a manner so as to evolve over time, touch resolution can be particularly tested. Also, by displaying the test image 616 in such a manner so as to evolve over time, “palm suppression” can be measured. In the touch controller, palm suppression allows the touch controller to ignore large areas on the touch panel experiencing a decrease in capacitance. The presumption is that these large areas are caused by a palm or a side of the hand (or other large conductive surface) unintentionally contacting the touch panel.

Again, it should be understood that the particular test images 602, 604, 606, 608, 610, 612, 614, and 616 are merely exemplary and numerous other test images can be utilized depending upon the embodiment or circumstances. Notwithstanding the discussion provided above particularly relating to the use of the second and third test images 604, 606 for calibration and testing purposes, it should also be appreciated that each of the test images 602, 604, 606, 608, 610, 612, 614, and 616, depending upon the embodiment or circumstance, can be useful for performing either calibration or for testing the operation of the touch panel (or other touch-sensitive device) in terms of its ability to detect touches.

For example, with respect to the fourth test image 608 showing ten of the white circles, such a test image is particularly helpful in testing the number of separate touches that an electronic device's touch system can track, which can be a significant operational parameter of the device. Typically, a touch system operates in a manner in which each new applied touch is given a number (until the touch is removed by the user), and some conventional electronic devices (e.g., mobile phones) can track up to ten individual touches. Thus, if the test image includes ten reasonably sized and reasonably spaced dots on the screen as is the case with the fourth test image 608, the testing process can proceed by determining whether ten touch reports are received from the touch system (as sensed by the touch panel), as well as determining whether the different touches are sensed to have occurred in the order in which the various dots were lit up (that is, the order in which the simulated touches occurred).

It is also possible for the touch panel testing to be performed not only to detect touches but also to detect the opposite of touches or “anti-touches”, such as can occur when a droplet of water falls on a touch screen (and which can appear as random formations of various shapes, albeit anti-water coatings on touch screens can often result in droplets that are substantially hemispherical). Such an event is an “anti-touch” particularly insofar as the capacitive effects of a user finger touching the touch screen are typically electrically opposite the effects of a drop of water (or similar anti-touch occurrence). That is, while a grounded Cadmium Sulfide component can simulate a finger touch insofar as it results in a decrease in capacitance measurement (or a “positive” signal), a non-grounded Cadmium Sulfide component can simulate water insofar as it results in an increase in capacitance measurement (or a “negative” signal).

That said, the ninth and tenth test images 618 and 620 are suited particularly for such touch panel testing pertaining to anti-touches. That is, the ninth test image 618 shows merely a completely blank white (or brightened) image, and this constitutes basically the reverse of the test image 602, and is appropriate for calibration purposes (e.g., for display in the step 509 of FIG. 5). The tenth test image 620 by comparison shows a pair of blackened (darkened) circles 821 that are surrounded by the white (or brightened) background. Thus the test image 620 is appropriate for testing the response of the touch panel (or other touch-sensitive device) to two anti-touches. Although the tenth test image 620 shows particularly the two circles 821 it should be appreciated that one circle or any other number of circles (or, indeed any number of any other shaped formations) can be utilized. Further, depending upon the test operation, the test image can be updated over time to allow the circles or other formations to move towards or away from one another or move or evolve in other manners similar to those discussed with reference to the test images 610, 612, 614 and 616. Thus, among other things, additional test images can be provided that are essentially inverted versions of the test images 604, 606, 608, 610, 612, 614, 616, etc.

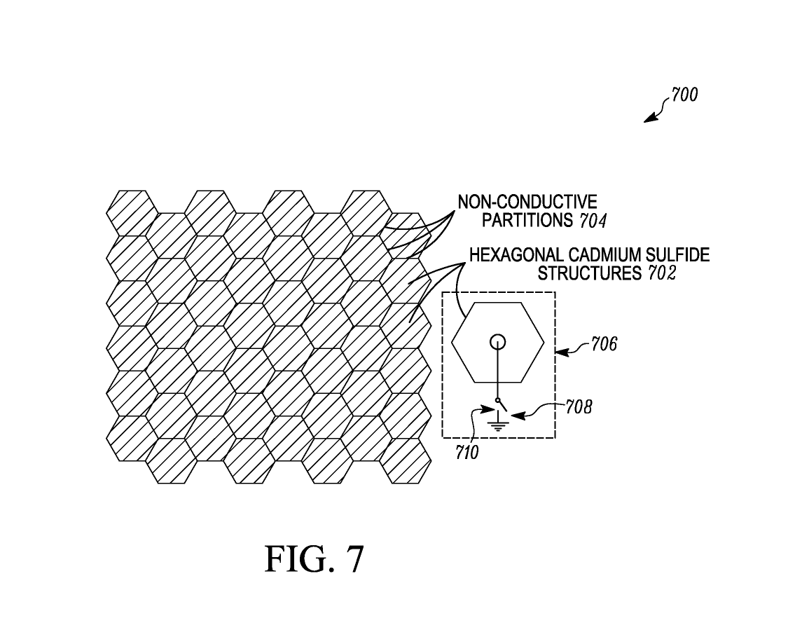

Turning to FIG. 7, although the photoconductive panel 102 and photoconductive panel 200 discussed above are continuous unitary sheets or panels of photoconductive material, in other embodiments the photoconductive panel need not take such a form but rather as shown in FIG. 7 can be formed as an array, lattice, or assembly of several photoconductive structures or photoconductive sections, which will be referred to herein as a photoconductive section array panel 700. In such a form, the photoconductive panel can also be viewed as a “pixilated” photoconductive panel. In the present example of FIG. 7, the photoconductive section array panel 700 particularly is made up of numerous hexagonal Cadmium Sulfide sections (or simply hexagonal sections) 702 that, in this case, are hexagonal in shape such that the sections can fit together in a complementary manner as shown.

It should further be appreciated that all of the adjacent hexagonal sections 702 of the array panel 700 are separated from one another electrically by insulative barriers or dividers, which can also be referred to as non-conductive partitions 704. Thus, it is possible for one of the hexagonal sections 702 to be conductive or to have a particular capacitance characteristic along its surface that forms part of the contact surface of the array panel (that is, the surface intended to contact a capacitive touch panel corresponding to the contact surface 104 discussed above), even though adjacent or neighboring one(s) of the hexagonal sections have an entirely different conductive and/or capacitance properties. Although the embodiment of FIG. 7 employs the hexagonal sections 702, it should be understood that the sections in other embodiments can take on a variety of other shapes (e.g., squares, rectangles, triangles, etc.) and fit together in a variety of manners (e.g., in a variety of manners akin to a parquet or mosaic floor).

FIG. 7 further provides a detail view 706 of one of the hexagonal sections 702 to show that, in at least some embodiments employing multiple sections that are electrically isolated from one another, each of the respective sections can have its own respective grounding contact circuit 708. Although in some embodiments, the grounding contact circuit of each section is simply an independent connection (short circuit) to ground, in the present embodiment, each ground contact circuit 708 includes a respective switch 710 that determines whether or not an Ohmic contact on the non-contact side of the section (that is, the outer surface 116 not intended to contact a touch panel or other touch-sensitive device) is in fact coupled to ground or not. By virtue of the ground contact circuits 708, the Ohmic contact on the reverse (non-contact) side of each of the hexagonal sections 702 can be either grounded or floating, to allow each section 702 to be seen, respectively, as a touch or anti-touch during testing of the touch panel or by a mutual capacitance touch system.

It should be noted that embodiments such as that of FIG. 7, in which the respective hexagonal (or other) sections of a photoconductive section array panel such as the array panel 700 have respective circuitry associated therewith, can include a variety of different types of circuitry depending upon the embodiment. In at least some embodiments, each of the sections can be viewed as (or as including) a respective electrode that can be independently turned on and off. Also, in at least some embodiments, each section of a photoconductive section array panel can be transistor-controlled via its own transistor-based circuitry. Or the photoconductive section array panel can be formed using a large wafer of photoconductive transistors.

Given such features, in at least some such embodiments, the photoconductive section array panel (or blotter) allows individual photoconductive sections or “pixels” to float or connect to Earth through electronically controlled switches, or take on any of a variety of different electrical characteristics on an individual basis. Partitioning among pixels is meant to provide isolation among pixels in order to define a clear boundary between conductive and non-conductive portions of the blotter. It should also be noted that Cadmium Sulfide material has a relatively slow half-life in terms of decaying from a conductive state back to a non-conductive state (e.g., seconds or even minutes). Thus, disconnecting a pixel from Ground forces the pixel to be non-conductive (even if the Cadmium Sulfide material itself is still conductive).

Pixel/section size can be smaller, equal to, or larger than resolution of a touch screen under test. In one example embodiment, each section 702 is approximately one millimeter in diameter. This arrangement can be chosen to accommodate corresponding capacitive touch systems, for example a touch system having a sensor grid pitch of 5 mm. With such dimensions, the touch system can report the centroid of a single simulated touch of 10 mm in diameter to an accuracy of 1 mm, and the touch system can resolve two smaller touches spaced diagonally about 7 mm apart, center to center. Thus, the resolution of the touch system (with the touch panel and optical display) should easily allow the test system to make 10-mm diameter optical patterns that can be used to test the touch system metrics listed above.

It should be appreciated that the photoconductive section array panel 700 of FIG. 7 as well as other array panels and similar structures can be used to achieve a variety of test procedures and functions. For example, in contrast to testing that involves use of a continuous unitary photoconductive panel, testing of a touch screen with an optical display that utilizes a photoconductive section array panel can produce distinctive test results in that a given test image can cause a pixilated conduction response in the array panel where specific discrete portions of the array panel corresponding to particular sections become conductive (but not others). Also for example, it is possible in some embodiments for testing of a touch screen to be achieved simply by electrically actuating different ones of the sections 702.

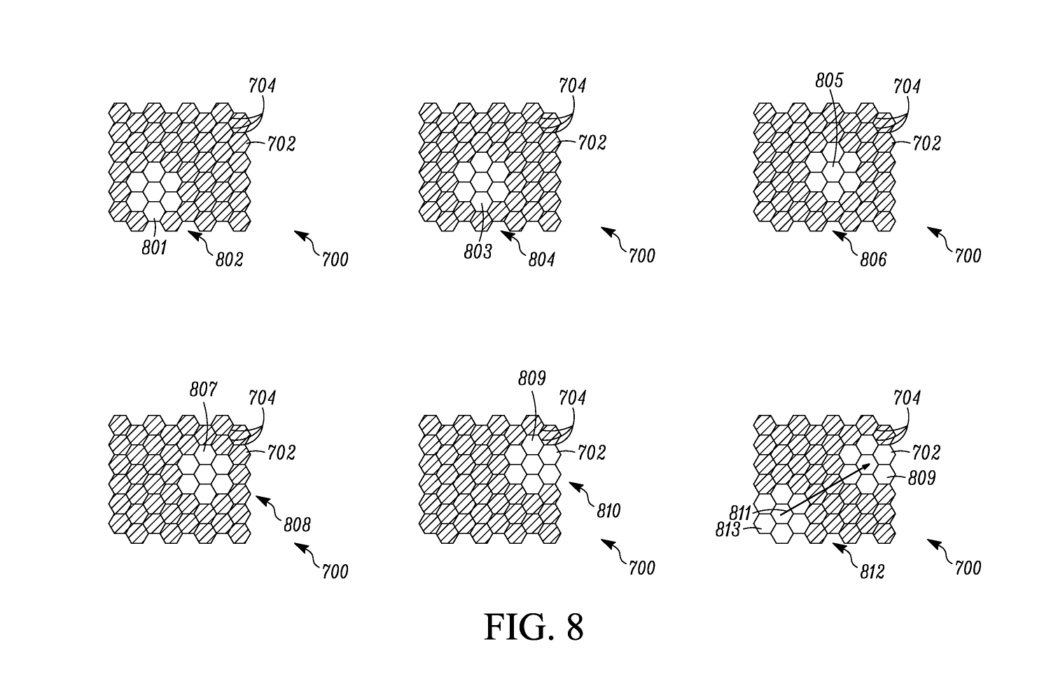

One example test procedure employing the photoconductive section array panel 700 of FIG. 7 is illustrated by FIG. 8. In this regard, FIG. 8 shows how the photoconductive section array panel 700 can be utilized to detect a swiping motion (or a moving test image corresponding to a swiping motion) as a series of successive slight movements across the photoconductive panel 700, such that different ones of the hexagonal sections 702 are actuated as the swiping motion occurs. More particularly as shown, FIG. 8 shows first, second, third, fourth, and fifth views 802, 804, 806, 808, and 810, respectively, of the array panel 700, where each of the views shows a different respective grouping 801, 803, 805, 807, and 809, respectively, of six of the hexagonal sections 702 to be illuminated (brightened) relative to the remaining hexagonal sections of the array panel.

Further as illustrated, the hexagonal structures included in each of the successive groupings 801, 803, 805, 807, and 809 switch on and off as the respective structure groupings are illuminated (that is, the structures switch on and off in terms of conducting), as one proceeds through the successive views 802, 804, 806, 808, and 810, in a manner correspond to a swiping touch that moves from one location along the array panel 700 (in this case, the lower left side of the array panel) to an other location along the array panel (in this case, the upper right side). This overall progression is represented by a further view 812, which shows both an initial grouping 813 of hexagonal sections corresponding to the beginning of the swiping motion and the grouping 809, which is the final grouping corresponding to the completion of the swiping motion, connected by an arrow 811.

Thus, simulation of a swiping motion can be achieved by illuminating different groupings of the hexagonal structures at different times so that the different groupings become electrically conductive (and thus are switched on and off) at different times. That is, by virtue of a given light pattern activating a cluster of adjacent pixels in the optically activated touch test system, and by virtue of actuating the entire pattern to move across the screen in steps, one pixel width per step, the effective result is simulation of a swipe touch gesture that is placed at one point on the touch screen, then slides, without lifting off, to another point on the touch screen, in the manner of a finger performing a swipe operation on the capacitive touch screen. This method of an optical swipe allows for the precise definition of the contact area and path of the optically activated touch, but due to potential electrical persistence in the photoconductive material, this process can be slower than an actual swipe performed by a finger in contact with the touch screen. However, if a series of individual, unconnected conductive regions are optically created at regular intervals along a straight or curved path in the plane of the touch screen, it becomes possible to emulate very fast finger swipes by successively switching the ground connection(s) for each optically defined conductive region in the series in a make-before-break fashion.

FIG. 8 is intended to illustrate a process in which the light pattern used to illuminate the different groups of the hexagonal sections of the photoconductive panel is dynamically changed, but in which the respective electrical switches associated the various hexagonal sections remain static. More particularly, in order for this process to simulate an “optical swipe”, all of the switches associated with the respective hexagonal sections are closed/short-circuited (such that there is conducting to ground) and remain so throughout the test. That said, it is also possible to simulate the inverse, representative of (for example) a water drop rolling across the touch screen, which can be considered an “anti-touch-swipe” or “anti-swipe”. For such a test, all of the switches associated with the different hexagonal sections would be open-circuited. In addition to these examples, numerous other gestures or touch movements can be simulated by appropriately shining particular light patterns upon the photoconductive panel with its numerous hexagonal sections or groups of such sections (or sections of other shapes).

It should further be noted that, with respect to the above examples (e.g., the swipe example of FIG. 8 and “anti-swipe” example), it is particularly the dynamic light pattern rather than any dynamic switching of the respective electric switches associated with the respective hexagonal sections that is creating the simulated moving contact. Nevertheless, in other embodiments or circumstances it is possible to simulate gestures or other touch movements instead by way of particular controlled activations of various ones of the switches (e.g., time-varying switch actuations or switch-activated conductance). Such switch-activated conductance can be performed both independently of or in conjunction with light-activated conductance, depending upon the embodiment or circumstance.

Additionally with respect to switch-activated conductance, achieving beneficial simulations particularly can be achieved by actuating (or “showing”), simultaneously, a group of individual optically-activated conductive regions that are sufficiently spaced from one another so that no two regions are seen by the touch system as a single touch. In embodiments such as that of FIGS. 7 and 8 in which the photoconductive panel is made of numerous small sections such as the hexagonal sections 702, it can again be the case that groups of sections are actuated together as a single region (such that simultaneous actuation of multiple regions involves simultaneous actuation of multiple groups of sections that are not adjacent to one another). In such embodiments, all electrical switches in contact with a common optically-activated conductive region should be operated together as a single switch. More particularly, during such operation, first all switches in the entire test system will be opened, then the optical patterns will be activated, and then the touch system will be calibrated. Then, by successively opening and closing the electrical connection for each respective optically-activated conductive region, it becomes possible to electrically emulate a very fast swipe along a static path defined by these same optically-activated regions.

Notwithstanding the above description relating to FIGS. 1-8, it should be appreciated that numerous variations of the embodiments, processes, and other concepts described above are intended to be encompassed by the present disclosure. For example, numerous additional processes combining one or more steps of any one or more of the processes described above are intended to be encompassed herein. As already discussed, combination processes are intended to be achieved. For example, one example method involving a photoconductive section array panel can involve a series of steps such as: placing the touch screen with optical display against the photoconductive panel (blotter); switching the optical display so that it is dark/black; turning on the touch screen touch panel; calibrating the touch screen touch panel with the photoconductive panel set to an off or zero level (or zero conduction level); turning on the electrodes in the photoconductive section array panel in a given pattern (can be sequential all or at once); capturing capacitance measurements from the touch screen touch panel; and calibrating the touch controllers.

Also, it should be appreciated that a variety of test apparatus are contemplated herein. As already noted above, in some embodiments, the testing process can be exclusively or substantially controlled simply by the DUT (e.g., by the processing portion 304 of the electronic device 100), or exclusively or substantially controlled by an external device such as the test computer 130, or by a combination of these other devices. Yet numerous variations on the manner of control can be employed depending upon the embodiment or circumstance. For example, if one includes a computer for controlling the optically activation, it is possible to perform testing of a very simple touch system that may not even have a host microprocessor. Also, an optically activated touch system can be simpler as the DUT gets more sophisticated (with greater processing power), up to the case where the optically activated touch system is just a simple sheet of Cadmium Sulfide, and “grounding” of a large, optically defined shape is provided by creating a very narrow, optically defined conducting pathway between the system ground and the optically defined shape meant to activate the touch screen.

Further, one or more of the technologies described herein as being used for testing purposes can also be used for other purposes. For example, it is also envisioned herein that a new imager technology can be developed utilizing one or more of the principles described herein. In at least some embodiments, a new imager technology can operate by allowing the photoconductive surface to be on top of a device, and allowing layers of metal to be provided over active devices—something which is in contrast to conventional complementary metal oxide semiconductor (CMOS) imagers, which allow no metal layers directly over the light-sensitive devices (and in which most or all of the active area consumed by the light-sensitive devices cannot be used for other devices or circuitry such as those used for digital or analog signal processing).

In view of the above, it should be appreciated that the embodiments and processes described above can be used to achieve a variety of goals and to provide a variety of benefits. Among other things, one or more of these concepts can be employed to achieve functional touch testing of smart phones or other electronic devices in production environments. Also, one or more of these concepts can be employed to perform minimum pinch distance testing. Further one or more of these concepts can be employed in kiosks and other devices employing touch screens to have built-in calibration capabilities (e.g., a touch-enabled kiosks with built in calibration system). Additionally, one or more of these concepts can be employed to perform water splash recovery testing, and hovering finger immunity (this can be performed particularly if the electronic device or phone is suspended above the photoconductive panel by a few millimeters using spacers, etc.).

It is specifically intended that the present disclosure not be limited to the embodiments and illustrations contained herein, but include modified forms of those embodiments including portions of the embodiments and combinations of elements of different embodiments as come within the scope of the following claims.

We claim:

1. A method of testing a capacitive touch-sensing component, the method comprising:
positioning a first surface of the capacitive touch-sensing component adjacent to a photoconductive material;
illuminating at least one portion of the photoconductive material;
detecting a status of at least one part of the capacitive touch-sensing component; and
determining whether the status or a characteristic relating to the status satisfies a requirement relative to the illuminating.

2. The method of claim 1, wherein the illuminating comprises:
actuating of an optical display component arranged behind a second surface of the capacitive touch-sensing component.

3. The method of claim 2, further comprising:
providing a conductive path from the at least one portion of the photoconductive material to a ground.

4. The method of claim 2, wherein the determining comprises:
comparing a first centroid of a first region illuminated on the optical display component with a second centroid sensed from the at least one part of the capacitive touch-sensing component.

5. The method of claim 2, wherein the detecting of the status includes at least indirectly receiving, at a processing device, a signal from at least one capacitor of the capacitive touch-sensing component.

6. The method of claim 2, further comprising:
receiving data concerning a test image, wherein the actuating is performed based upon the data received.

7. The method of claim 6, wherein the test image is configured to include one or more substantially round formations that are surrounded by a background, and wherein the one or more formations is brighter than the background.

8. The method of claim 6, wherein the test image is configured to include one or more substantially round formations that are surrounded by a background, and wherein the background is brighter than the one or more formations.

9. The method of claim 6, wherein the illuminating is performed over a period of time in a manner so that, at a first time, a first portion of the at least one portion is illuminated and, at a second time, a second portion of the at least one portion is illuminated, the second portion being different than the first portion.

10. The method of claim 1, further comprising:
calibrating the capacitive touch-sensing component prior to the illuminating.

11. The method of claim 1, wherein the detecting occurs at a first time, and further comprising:
performing one or more additional detecting operations at one or more additional times subsequent to the first time.

12. The method of claim 11, wherein the determining includes:
additionally determining whether a change in the status has occurred between the first time and a first additional time, and wherein when the change in the status is additionally determined to have occurred between the first time and the first additional time, the change in the status is interpreted as a user touch and not as an environmental condition drift.

13. The method of claim 1, further comprising:
positioning one or more additional capacitive touch-sensing components adjacent to the photoconductive material.

14. The method of claim 1, wherein the photoconductive material includes a plurality of subportions that are electrically isolated from one another, and further comprising:
during a first time period, enabling a first conductive path from a first subportion to a ground and inhibiting a second conductive path from a second subportion to the ground; and
during a subsequent time period, inhibiting the first conductive path from the first subportion to the ground and enabling the second conductive path from the second subportion to the ground.

15. An apparatus for testing a capacitive touch screen, the apparatus comprising:
a photoconductive structure having a first surface that is configured to be positioned adjacent to a complementary surface of the capacitive touch screen,
wherein the photoconductive structure is operable to receive light from a light source and to experience a conductance change along at least one portion of the first surface at which the light is received.

16. The apparatus of claim 15, wherein the photoconductive structure is made at least partly from Cadmium Sulfide.

17. The apparatus of claim 16, wherein the photoconductive structure includes a plurality of sections that are all arranged along the first surface and that are electrically isolated from one another.

18. The apparatus of claim 17, wherein:
the photoconductive structure includes a plurality of switching circuits that each are actuatable to couple a respective section of the plurality of sections to a ground.

19. A capacitive touch screen testing apparatus comprising:
a capacitive touch sensing component;
an optical display component;
at least one memory component configured to store test image information; and
at least one processing component coupled at least indirectly to each of the capacitive touch sensing component, the optical display component, and the at least one memory component,
wherein the at least one processing component is configured to (1) make a determination, based upon first signals communicated between the at least one processing component and the capacitive touch sensing component and second signals communicated between the at least one processing component and the optical display component, of an extent to which one or more changes in capacitance sensed by the capacitive touch sensing component correspond to one or more images displayed by the optical display component based upon the test image information, and (2) control a calibration of one or more of the capacitive touch sensing component and the optical display component based upon the determination.

20. The capacitive touch screen testing apparatus of claim 19,
wherein the determination is performed by either (a) a first processor of the at least one processing component that is in addition to and distinct from an electronic device on which the capacitive touch sensing component is implemented, or (b) a second processor of the at least one processing component that is comprised by the electronic device on which the capacitive touch sensing component is implemented; and
wherein the determination involves either a first conclusion that the capacitive touch sensing component is performing adequately or a second conclusion that the capacitive touch sensing component is performing inadequately.
